(19) United States
(12) Patent Application Publication
(10) Pub. No.: US 2026/0131366 A1
(43) Pub. Date: May 14, 2026

(54) PLANT AND METHOD FOR TREATING ORGANIC WASTE

(71) Applicant: ENTSORGAFIN S.P.A., TORTONA (AL) (IT)

(72) Inventors: Pietro Paolo CELLA MAZZARIOL, Tortona (AL) (IT); Gian Francesco GALANZINO, Tortona (AL) (IT)

(21) Appl. No.: 18/696,441

(22) PCT Filed: Oct. 7, 2022
(86) PCT No.: PCT/IB2022/059589

§ 371 Date: Mar. 28, 2024

(30) Foreign Application Priority Data
Oct. 8, 2021 (IT) 102021000025766

(51) Int. Cl. B09B 3/65; B03B 9/06; B09B 3/35; C10L 3/08; C10L 5/48

(52) U.S. Cl. CPC B09B 3/65; B03B 9/06; B09B 3/35; C10L 3/08; C10L 5/48; C10L 2290/26

(57) ABSTRACT

A plant and a method for treating organic waste are provided. The plant and method provide an integrated system for waste treatment which allows optimization of the re-use of treated organic waste, by recovering and exploiting all the components of the incoming waste. After a series of pretreatment operations intended to separate the organic fraction from ferrous, plastic and inert materials, the treated waste is subjected at first to an anaerobic treatment with production of biogas and digestate, and the digestate is then subjected to an aerobic treatment with production of compost. Advantageously, the plant and method provide that handling of the waste to be treated takes place in an automated manner, thus reducing personnel exposure to bad odors and contaminants.

### TECHNICAL FIELD

The present invention relates to a plant for treating organic waste, namely waste having a highly fermentable organic component.

In particular, the present invention relates to an integrated, synergic plant allowing maximum optimization of the processes of recovery and reuse of said organic waste.

The present invention further relates to a method for treating municipal solid waste that can be implemented in the aforesaid plant.

The present invention finds particular application in the treatment of the organic fractions of municipal solid waste (OFMSW) deriving from waste sorting.

### BACKGROUND ART

Plants and methods are known for the aerobic treatment of solid waste and, in general, of materials containing putrescible substances.

The aerobic treatment under controlled conditions allows to provide the oxygen required by the microorganisms responsible for the process of destruction of biological components by means of spontaneous aerobic fermentation.

In general, the plants and methods for the aerobic treatment of waste provide for a biological treatment by means of a first step of accelerated fermentation, during which waste is usually arranged in heaps on a perforated floor and an air flow under a forced ventilation regime passes therethrough, and a subsequent step of slow maturation in a closed environment.

At the outlet of plants for the aerobic treatment of waste, a compost is obtained, which can advantageously be used as fertilizer in agriculture. The use of compost in agriculture is, by the way, considered a practice with high energy value and is strongly encouraged as it enriches the soil with organic matter and helps the progressive accumulation of carbon in the soil (“carbon sink”).

Plants and methods for the anaerobic treatment of organic waste and, in general, of materials containing putrescible substances, are also known in prior art.

The anaerobic treatment, or anaerobic digestion, also makes use of several species of microorganisms (especially bacteria), each of which plays a different role at a different step of the digestion process.

In general, the plants and methods for the anaerobic treatment of waste provide for a first step of hydrolysis, in which organic molecules are cleaved into simpler compounds such as monosaccharides, amino acids and fatty acids, a second step of acidogenesis, in which a further cleavage into even simpler molecules, such as volatile fatty acids, takes place, with production of ammonia, carbon dioxide and hydrogen sulfide as by-products, a third step of acetogenesis, in which the simple molecules produced at the preceding step are further digested, thus producing carbon dioxide, hydrogen and acetic acid, and a fourth and last step of methanogenesis, with production of methane, carbon dioxide and water.

It is evident from the above that, at the outlet of plants for the anaerobic treatment of waste, biogas is obtained, which is collected by means of appropriate collection devices provided in anaerobic digesters.

Said biogas can be used for producing thermal energy, by means of boiler combustion, for producing electric power, by means of electric generating sets, or for producing both, by means of cogeneration sets.

For example, documents US 2012/190102, US 2020/316661 and U.S. Pat. No. 9,700,896 disclose waste treatment plants and methods involving the use of an aerobic treatment station (aerobic digester) and an anaerobic treatment station (anaerobic digester).

In the plants and methods described in these documents, the aerobic digester and the anaerobic digester are arranged in parallel and, depending on the needs, waste can be subjected to an aerobic treatment only, or, in alternative, to an anaerobic treatment only.

Both aerobic treatment plants and methods and anaerobic treatment plants and methods currently known, however sophisticated, have some limitations, especially in terms of efficiency of the process of waste reuse and minimization of remains to be discarded.

In particular, as far as anaerobic digestion is concerned, such digestion, in addition to biogas, provides a digestate, which has to be subjected to further treatment steps (sometimes also very expensive) before being capable of being used as fertilizer or disposed of.

Further concerns affecting all waste treatment plants and methods of known type relate to the safety of the personnel, who operate in potentially unhealthy conditions, and the diffusion of bad odors and contaminants into the external environment.

The main object of the present invention is thus to provide a plant and a method that allow for a synergic treatment of organic waste, with consequent optimization of the process of reuse of treated waste.

Another object of the present invention is to provide a plant and a method that allow for a highly automated treatment of organic waste so as to reduce personnel exposure to odors and contaminants.

A further object of the present invention is to provide a plant and a method that allow for an organic waste treatment with lower energy consumption and management costs.

These and other objects of the invention are achieved with the plant and the method as claimed in the appended claims.

### SUMMARY OF INVENTION

The invention aims at providing a waste treatment integrated system that allows to optimize reuse of treated organic waste, by recovering and exploiting all the components of the incoming waste.

To this end, the plant according to the invention substantially comprises:
a receiving station for receiving organic waste,
a shredding station,
a station for removing ferrous materials,
a station for removing plastic and inert materials,
an anaerobic treatment station with production of biogas and digestate,
an aerobic treatment station for aerobically treating said digestate,
   said aerobic treatment station for the digestate being arranged in series with said anaerobic treatment station and receiving at its inlet the digestate produced by said anaerobic treatment station.

Similarly, the method according to the invention substantially comprises:
a receiving step for receiving organic waste,
a shredding step,
a step of removing ferrous materials,
a step of removing plastic and inert materials,
an anaerobic treatment step with production of biogas and digestate,
an aerobic treatment step for aerobically treating said digestate,
   said aerobic treatment step for the digestate being provided in series with said anaerobic treatment step for said organic fraction and receiving at its inlet the digestate produced at said anaerobic treatment step.

Thanks to the integration of the aforementioned stations/steps, the invention allows optimization of the management of treated waste and minimization of remains to be discarded.

In particular, ferrous materials are effectively separated for subsequent recycling; plastic and inert materials are also effectively separated and can be fed to a dedicated treatment line and there they can be used for producing secondary solid fuel; the remaining organic fraction, thus purified from foreign bodies, is effectively exploited for producing at first biogas and then compost.

Preferably, the plant and the method according to the invention can further comprise a system for the recirculation and use of leachates, thus also exploiting and disposing of the leachates that will inevitably be present together with the incoming organic waste.

Advantageously, the integration of the aforementioned stations also makes it possible to obtain a plant with a compact overall structure, in which organic waste are fully treated over a limited area, without having to transport it between different sites.

This results, among other things, in a reduction of management costs for waste treatment.

Furthermore, the plant according to the invention is advantageously scalable and can be built with size and catchment area size and capacity that differ according to the needs.

Advantageously, in the plant according to the invention, the transfer from one station to another takes place in an automated manner, thus reducing personnel exposure to bad odors and contaminants.

In particular, the waste receiving station is equipped with an overhead crane system making it possible to avoid handling with shovels, usually employed in systems of known type for feeding to the shredding station.

Similarly, feeding to the anaerobic treatment station takes place by means of an overhead crane system and a closed duct arrangement so as to prevent diffusion of odors and avoid handling with shovels.

For the same reasons, also the feeding of the digestate to the aerobic treatment station also takes place by means of a system of closed conduits.

In a preferred embodiment of the invention, the plant / method according to the invention comprises an upgrading station / step for upgrading the biogas obtained at the outlet of the anaerobic treatment station, with production of biomethane.

### BRIEF DESCRIPTION OF DRAWINGS

Further features and advantages will become apparent from the detailed description of a preferred embodiment of the present invention, which will be described below with reference to the annexed drawings, in which:

FIG. 1 schematically shows, in the form of a block diagram, the layout of the plant according to the invention;

FIG. 2 schematically shows the waste receiving station and the group of pre-treatment stations of the plant of FIG. 1;

FIG. 3 schematically shows the anaerobic treatment station of the plant of FIG. 1;

FIG. 4 schematically shows the aerobic treatment station of the plant of FIG. 1.

### DESCRIPTION OF EMBODIMENTS

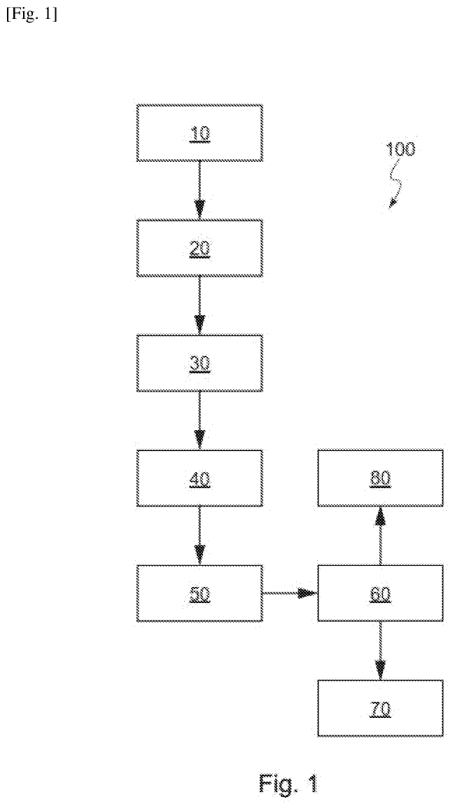

FIG. 1 schematically shows the overall layout of the plant 100 according to the invention. First of all, said plant 100 comprises a receiving station 10 for receiving organic waste. Although the invention can generally be applied to the treatment of any type of waste comprising a putrescible organic fraction, it finds particular application in the treatment of the organic fraction of municipal solid waste (OFMSW) deriving from waste sorting.

In the receiving station 10, therefore, organic waste contained in bags will be unloaded from trucks carrying the waste to the site of the plant 100.

The plant 100 further comprises a group of pre-treatment stations (indicated by the dashed line in FIG. 1), essentially adapted to separate the organic fraction of the incoming waste by means of essentially mechanical processes.

The group of pre-treatment stations mainly comprises:
a shredding station 20, in which the bags containing the waste are opened and their contents are exposed for subsequent operations;
a station for removing ferrous materials 30, in which the ferrous material are separated magnetically;
a station for removing plastic and inert materials 40, in which the plastic and inert materials are separated mechanically and extracted from the waste flow.

At the outlet of the group of pre-treatment stations, a nearly pure organic fraction in the form of a sludge or slurry (ingestate), which is stored in a collection tank 50.

Advantageously, the receiving station 10, the group of pre-treatment stations 20-40 and the collection tank 50 can be housed in one and the same closed environment, i.e., in one and the same shed, as will be described in more detail below.

In a possible application of the invention, the plant 100 receives at its inlet, in addition to the OFMSW, also some quantity of mowed (“green”) material.

In general, said mowed material is added in the desired proportions to the OFMSW in the shredding station 20.

This allows, among other things, for a certain degree of mixing between the OFMSW and the mowed material during passage through the following pre-treatment stations.

However, it is also possible to provide that the mowed material is directly introduced into the collection tank 50.

The plant 100 further comprises an anaerobic treatment station 60, to which the organic fraction is fed from the collection tank 50.

The anaerobic treatment station 60 essentially comprises one or more anaerobic digesters, which allow to obtain biogas from the incoming organic fraction (ingestate).

In the shown embodiment, said biogas is further sent to an upgrading station 70, which separates methane from carbon dioxide and allows to obtain biomethane.

The anaerobic treatment station 60 further provides, in addition to biogas, a digestate as a by-product.

The plant 100 according to the invention advantageously provides for combining, in an integrated and synergic manner, anaerobic treatment processes and aerobic treatment processes.

Said plant thus comprises an aerobic treatment station 80 which receives at its inlet the digestate coming from the anaerobic treatment station 60.

In the aerobic treatment station 80, the digestate undergoes a composting process.

Advantageously, contrary to the conventional aerobic treatments, which provide for a first aerobic fermentation sub-station and a second slow maturation sub-station, in the aerobic treatment station 80 the treatment of the digestate can take place in a single step, thanks to the fact that the digestate has already been subjected to microbiological phenomena of decomposition in the anaerobic treatment station 60.

Preferably, in said aerobic treatment station, organic waste and mowed material are added as structuring material to the digestate in order to obtain a mixture with the desired characteristics.

From the description provided above of the overall layout of the plant 100, the advantages of the invention are evident: thanks to the group of pre-treatment stations, the various components of the incoming waste are separated and the remains to be discarded are minimized; the production of biogas by the anaerobic treatment station allows to obtain energy self-sufficiency of the plant; the subsequent aerobic treatment allows to treat the digestate inside the same plant and to obtain a high-quality compost.

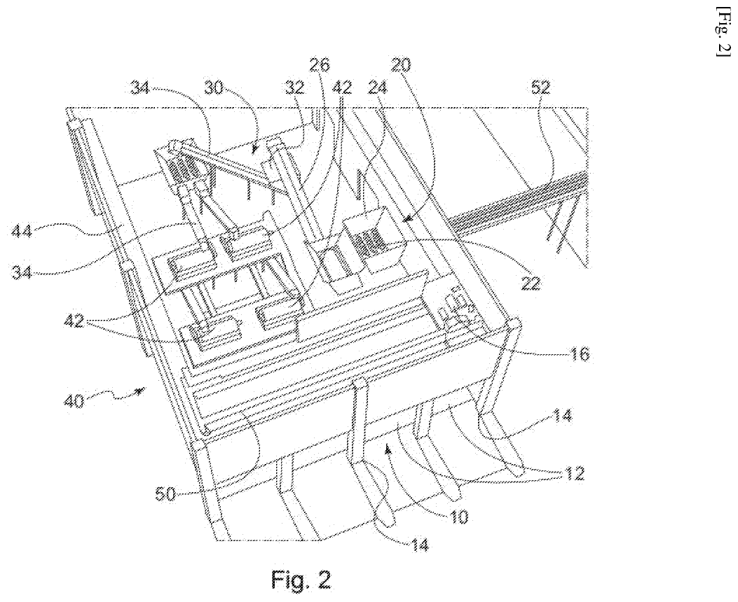

Turning now to FIG. 2, the shed housing the receiving station 10, the group of pre-treatment stations 20-40 and the ingestate collection tank 50 is described in more detail.

The receiving station 10 comprises one or more receiving pits 12, in which the organic waste contained in bags coming from the waste sorting of municipal waste (OFMSW) is unloaded.

At the receiving pits 12, the shed will be provided with doors 14 having shutters or similar closing member, which will be opened only at the time of unloading waste from the truck, thus making it possible to minimize the diffusion of odors in the outer environment.

Also, a double-door system (a first door between the outer environment and an intermediate environment, and a second door between said intermediate environment and the collection pits) may possibly be provided in order to obtain an even more effective reduction in the diffusion of odors in the outer environment.

Also, the shed housing the receiving station 10, the group of pre-treatment stations 20-40 and the ingestate collection tank 50 can be kept under light vacuum conditions, in order to prevent the diffusion of odors and other contaminants in the outer environment.

Advantageously, the receiving station 10 is further provided with an automated overhead crane system 16 with electrohydraulic bucket for transferring waste to the pre-treatment stations.

The implementation of an automated overhead crane system 16 (instead of the conventional handling systems with shovels) allows to avoid the presence of workers inside the receiving station 10, thus preventing exposure of workers to bad odors and contaminants.

The receiving station 10 will preferably provide for leachate collection tanks (not shown in FIG. 2) arranged beneath the receiving pits 12 and intended for collecting those leachates that inevitably form during transport of organic waste and subsequent storage thereof in the receiving pits.

From the receiving station 10, the waste is transferred to the group of pre-treatment stations, and in particular to the shredding station 20, by means of the overhead crane system 16.

Said shredding station 20 essentially comprises a hopper 22 inside which the waste is deposited by the overhead crane system 14 and a shredding device 24 which tears off the bags containing the waste in order to expose the waste for the subsequent pre-treatment operations, and in such a way as to reduce the size thereof to values in the order of 200-300 mm.

The shredding device 24 also allows to homogenize the treated material by shredding the coarser pieces. This aspect assumes specific relevance in the case in which mowed material is added to the organic waste in the shredding station 20. In addition, the shredding device 24 prevents possible large-sized foreign objects, present in the incoming material as a result of incorrect waste sorting, from damaging the devices of the following stations.

From the shredding station the waste is transported, by means of one or more mechanical conveyors 26 (such as, for example, screw feeders or belt conveyors), to the following station for removing ferrous materials 30.

Said station for removing ferrous materials 30 essentially comprises one or more magnetic separators 32 (such as, for example, magnetic belts or magnetic drums, either with permanent magnets or with electromagnets), which are arranged along the conveyors 26 and extract, by magnetic attraction, the ferromagnetic metals present in the treated waste.

Said ferromagnetic metals are then mechanically removed from the surface of the magnetic separators 32 and discarded at an appropriate collection site.

From the station for removing ferrous materials, the waste is transported, by means of one or more additional mechanical conveyors 34 (these, too, being made, for example, as screw feeders or belt conveyors), to the following station for removing plastic and inert materials 40.

Said station for removing plastic and inert materials 40 essentially comprises one or more squeezing devices 42 allowing effective removal of the organic fraction from plastic rejects.

Said squeezing devices 42 comprise a rotor with perforated drum, equipped with hammers and clubs, the joint movement of which makes it possible to separate plastic and inert materials from the organic fraction.

Thanks to the joint action of the rotating drum and the hammers, the treatment makes it possible to separate the organic component in the form of slurry from the scrap materials (mainly plastic materials).

In particular, the station for removing plastic and inert materials 40 allows to obtain at the outlet a nearly pure organic fraction, with an overall contamination lower than 3% by weight as it is, and even lower than 1% for plastics considered individually; said organic fraction will be in the form of a sludge with particle size of 0-20 mm and moisture of 65-80% by weight.

On the other hand, the station for removing plastic and inert materials 40 also allows to obtain plastic rejects effectively cleaned from organic matter, with a contamination with organic matter in the order of 30%- 40% by weight, and even lower than 30% by weight, and moisture of 40-60 % by weight.

From the station for removing plastic and inert materials 40, the plastic rejects are carried to an appropriate collection site by means of conveyor belts 44.

The plastic rejects thus separated and freed from organic matters can be used for producing secondary solid fuel, thus avoiding final disposal in landfill.

The treatment stations for obtaining secondary solid fuel from plastic rejects can be part of the plant 100 according to the invention, or they can constitute a separate plant.

In the first instance, in particular, they can efficiently be integrated in the aerobic treatment station 80.

In both cases, the plant 100 according to the invention advantageously allows to recover materials that would otherwise by discarded, for producing secondary solid fuels from organic waste (particularly OFMSW), and this thanks to the efficiency of the pretreatment and the separation and selection of the organic fraction from plastic contaminants.

The purified organic fraction exiting the station for removing plastic and inert materials 40 (ingestate) is, instead, transferred to the collection tank 50 for the subsequent anaerobic treatment.

In a preferred embodiment of the invention, the anaerobic treatment station comprises one or more “plug flow” digesters.

Correspondingly, the collection tank 50 is provided, at its bottom, with one or more screws pushing the ingestate towards one or more ingestate feed pumps (preferably at least two feed pumps working alternatively).

The feed pumps are low-speed positive displacement pumps comprising a pair of shutters and a delivery piston: by opening and closing alternatively the shutters and by actuating the delivery piston it is possible to push the ingestate into a duct arrangement 52 connecting the connection tank to the anaerobic treatment station.

It will be evident to the person skilled in the art that, advantageously, the use of a feed pump in combination with a plug flow digester allows to transfer the ingestate to the anaerobic treatment station through a completely closed connection, without release of odors, without risks of ingestate leakage and without any direct intervention by an operator for the transfer to the digester.

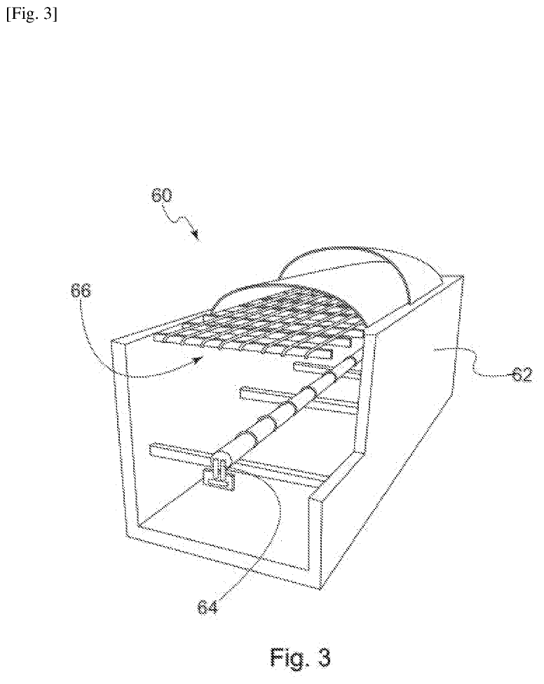

A plug flow digester 62 of the anaerobic treatment station 60 is schematically shown in FIG. 3.

The plug flow digester 62 is a reactor made of concrete and developing substantially in a horizontal direction, with substantially rectangular cross-section and plan.

Generally, it can operate under mesophilic conditions (with temperatures of about 38-42° C.) or under thermophilic conditions (with temperatures of about 50-55° C.), depending on the characteristics of the ingestate.

If the plant 100 is applied to the treatment of OFMSW, mesophilic conditions are usually preferable.

At its inside, the digester 62 comprises an axial stirrer with blades 64, which ensures handling of the treated material. By exploiting the principle of floatability of the shaft of the stirrer 64 when the digester is full, no central support is required and the shaft is located in the correct stirring position inside the digester and avoids vertical layering of the material.

Advantageously, the absence of central supports allows to remove all maintenance points inside the digester and to remove removes inner areas subject to wear and tear, thus reducing maintenance costs.

Of course, the digester 62 is provided with suitable detection and safety devices, especially for detecting any underpressures or overpressures therein.

The biogas produced forms in the free area 66 under the roof of the digester 62 and flows towards an exit line thanks to a light overpressure.

The methane content in the thus obtained biogas may vary between 55% and 65%.

As mentioned above, the plant 100 further comprises, preferably, an upgrading station 70 for refining the biogas and separating methane from carbon dioxide, this resulting in a production of biomethane.

The digestate produced in the digester is partly recycled at the inlet of the digester 62 and partly transferred to the aerobic treatment station 80.

The recirculation of part of the digestate makes it possible to have, in the initial part of the digester, a biomass already active and homogeneous with respect to the remaining material under digestion, which involves better kinetics of activation of methanogenic processes and better process inertia of the reactor.

Advantageously, in the plant according to the invention, the remaining portion of digestate can be integrally transferred to the aerobic treatment station 80 without having to separate the solid phase of the digestate from the liquid phase of the digestate.

Even in the case in which a separation of solid phase and liquid phase of the digestate is provided for whatever reason, both the solid phase and the liquid phase can be sent to the aerobic treatment station 80.

This constitutes a substantial difference with respect to the known systems, in which the solid phase and the liquid phase of the digestate are treated separately from each other.

In particular, the plant 100 according to the invention makes it possible to eliminate processing stations dedicated to the treatment of the liquid phase of the digestate (wastewater), because said liquid phase is nearly completely recycled and disposed of in the same processing station (the aerobic treatment station 80) that receives the solid phase of the digestate and the remaining part can be sent to external treatments, which, because of the small quantities, will have no relevant impact on the economy of the plant.

Accordingly, the invention allows a dramatic reduction in the complexity of the plant, with consequent reduction in space requirements as well as in installation and management costs.

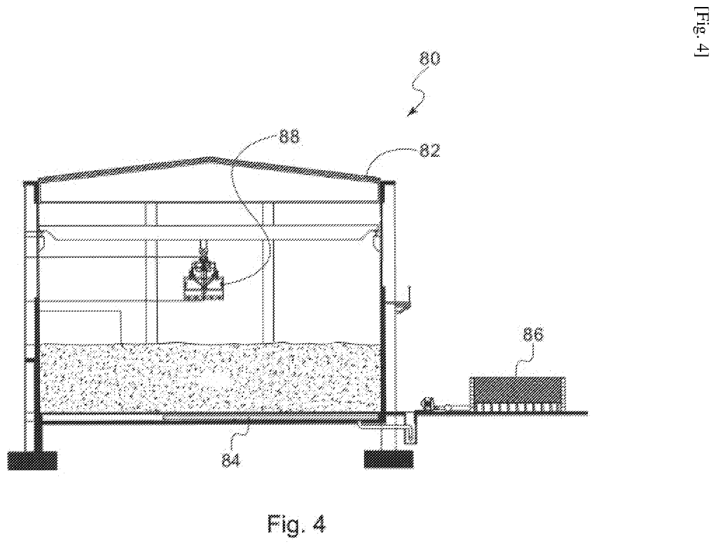

The aerobic treatment station 80 of the plant 100 is schematically shown in FIG. 4.

Said aerobic treatment station 80 comprises a closed reactor 82 provided with an aerated floor 84 on which the material to be treated is arranged in heaps.

Unlike the conventional treatment systems, in which the closed reactor is divided in two environments and the aerobic treatment takes place in two steps (aerobic fermentation+slow maturation), the aerobic treatment station provides that the closed reactor 82 comprises a single environment and that the aerobic treatment takes place in a single step.

This is made possible essentially by the fact that the aerobic treatment station 80 receives at its inlet the digestate, which has already undergone an anaerobic treatment inside the digester.

At the inlet of the aerobic treatment station, the digestate is mixed with structuring material (organic waste, mowed material).

The mixture thus obtained is subjected to a step of biological treatment by means of forced aeration of the heaps, by exploiting the heat developed by biological aerobic reactions.

The initial decomposition of the substrate is due to the action of microbial mesophilic species (25-35° C.), which rapidly use soluble and easily degradable compounds.

The heat generated by the metabolism of said microorganisms contributes to increase the temperature of the heap, because of the poor conductivity of the treated material.

As a result of the progressive development of heat, the temperature of the heap starts increasing, quickly exceeding the thermophilic threshold: as soon as the temperature exceeds 40° C., the mesophilic microorganisms become less competitive, and thus are progressively replaced by thermophilic species.

The optimal temperature range in which said microorganisms grow is between 50° C. and 65° C. During these steps, the high temperatures accelerate the degradation of proteins, lipids and complex carbohydrates, such as cellulose and hemicellulose.

In order to properly aerate the heap, forced circulation means are provided for blowing air into said heap and/or suck air therefrom through the floor 84.

Preferably, the air is sucked through the heap, which avoids the need to use additional ventilation systems for sending air to the following depuration devices, especially to the biofilter 86.

Also in the aerobic treatment station, the material to be treated and the compost obtained are handled by means of an automated overhead crane system 88 with electrohydraulic bucket, which avoids the presence of personnel inside the station.

Advantageously, the aerobic treatment station 80 has a very high evaporation capacity. As a result, the leachates collected in the receiving station 10 can be transferred to the aerobic treatment station 80, where they can be recycled for wetting the heaps of materials being treated.

In this way, a double advantage is achieved, because on one hand the proper humidity level of the heaps is maintained, while at the same time reducing the use of “clean” water, and on the other hand the leachates are disposed of without any additional cost.

Downstream of the aerobic treatment station, a station may possibly be provided for refining the compost before storage.

It is thus evident that the invention makes it possible to achieve the objects set forth, as it provides an integrated system which allows to minimize the area required to perform a synergic treatment of waste, by means of which waste can be re-used in an optimized manner.

Furthermore, the high automation grade makes it possible to minimize human intervention, thus preventing workers from being subjected to a potentially unhealthy working environment.

Still in order to prevent workers from being subjected to a potentially unhealthy working environment, all the environments of the plant that generate air to be treated (the receiving station 10, the pretreatment stations 20-40, the aerobic treatment station 80, etc.) are preferably provided with means for extracting and processing air, together with means for subsequent biofiltration and deodorization thereof.

In addition, such environments are preferably kept under light vacuum conditions in order to prevent diffusion of odors into the surrounding environment.

Finally, it is evident that the embodiment described above has been given merely by way of example and that numerous variants, both in the structure of the single working stations and in the provision of other auxiliary stations are possible without thereby departing from the scope of protection as defined by the appended claims.

1. A plant for treating organic waste, wherein the organic waste comprises an organic fraction and inorganic materials, and wherein the plant comprises:
a receiving station for receiving the organic waste;
a shredding station (20);
one or more separation stations for separating the inorganic materials from the organic waste and selecting the organic fraction of the organic waste;
an anaerobic treatment station for anaerobically treating the organic fraction of the organic waste, wherein biogas and digestate are produced from the organic fraction of the organic waste in the anaerobic treatment station;
an aerobic treatment station for aerobically treating the digestate;
wherein the aerobic treatment station for treating the digestate is arranged in series with the anaerobic treatment station for treating the organic fraction of the organic waste and wherein the aerobic treatment station receives at an inlet the digestate produced by the anaerobic treatment station.

2. The plant according to claim 1, wherein the inorganic materials of the organic waste include ferrous materials, plastic materials, or inert materials, and wherein the one or more separation stations for separating the inorganic materials from the organic waste and selecting the organic fraction of the organic waste comprise at least a station for removing ferrous materials and/or a station for removing plastic and inert materials.

3. The plant according to claim 1, wherein the receiving station (10) comprises one or more receiving pits and an overhead crane system for transferring the organic waste from said the receiving pits to the shredding station

4. The plant according to claim 2, wherein the one or more separation stations for separating the inorganic materials from the organic waste and selecting the organic fraction of the organic waste comprise at least a station for removing ferrous materials and the station for removing ferrous materials comprises one or more magnetic separators.

5. The plant according to claim 2, wherein the one or more separation stations for separating the inorganic materials from the organic waste and selecting the organic fraction of the organic waste comprise at least a station for removing plastic and inert materials and the station for removing plastic and inert materials comprises one or more squeezing devices.

6. The plant according to claim 5, wherein, at an outlet of the station for removing plastic and inert materials, an organic fraction purified from plastic and inert materials and plastic rejects cleaned from organic matter are obtained wherein the organic fraction purified from plastic and inert materials is transferred to the anaerobic treatment station and the plastic rejects cleaned from organic matter are transferred to a secondary solid fuel production station.

7. The plant according to claim 1, wherein said the anaerobic treatment station comprises one or more plug flow digesters.

8. The plant according to claim 7, wherein the plant comprises, downstream of the one or more separation stations for separating the inorganic materials from the organic waste and selecting the organic fraction of the organic waste, a collection tank for collecting the organic fraction of the organic waste and said wherein the collection tank is equipped with one or more feed pumps and with a duct arrangement connecting the collection tank to the anaerobic treatment station.

9. The plant according to claim 1, further comprising an upgrading station for refining the biogas and producing biomethane.

10. The plant according to claim 1, wherein the aerobic treatment station comprises a closed reactor provided with an aerated floor and with means for circulating air through the aerated floor.

11. The plant according to claim 10, wherein the digestate includes a liquid phase and a solid phase and wherein the aerobic treatment station receives at an inlet both the liquid phase and the solid phase of the digestate coming from said the anaerobic treatment station.

12. The plant according to claim 1, wherein leachate is produced in the receiving station and wherein the plant comprises an arrangement for recirculating the leachate from the receiving station to the aerobic treatment station.

13. A method for treating organic waste, wherein the organic waste comprises an organic fraction and inorganic materials, and wherein the method comprises:
a receiving step for receiving the organic waste;
a shredding step;
one or more separation steps for separating the inorganic materials from the organic waste and selecting the organic fraction of the organic waste;
an anaerobic treatment step for anaerobically treating the organic fraction of the organic waste, wherein biogas and digestate are produced from the organic fraction of the organic waste in the anaerobic treatment step;
an aerobic treatment step for aerobically treating the digestate;
wherein the aerobic treatment step for the digestate is provided in series with the anaerobic treatment step for the organic fraction of the organic waste and receives an inlet the digestate produced by the anaerobic treatment step.

14. The method according to claim 13, wherein the inorganic materials of the organic waste include ferrous materials, plastic, or inert materials, and wherein the one or more separation steps for separating the inorganic materials from the organic waste and selecting the organic fraction of the organic waste comprise at least a step of removing ferrous materials or a step of removing plastic and inert materials.

15. The method according to claim 13, further comprising an upgrading step for refining the biogas.

16. The method according to claim 13. wherein the digestate includes a liquid phase and a solid phase, wherein, in the aerobic treatment step for the digestate, the solid phase and liquid phase of the digestate are treated together.

17. The method according to claim 16, wherein the aerobic treatment step takes place in a single aerobic fermentation step.

18. The plant according to claim 1, wherein the digestate includes a liquid phase and a solid phase and wherein the aerobic treatment station receives at an inlet both the liquid phase and the solid phase of the digestate coming from the anaerobic treatment station.
